(19) United States
(12) Patent Application Publication
(10) Pub. No.: US 2025/0286301 A1
(43) Pub. Date: Sep. 11, 2025

(54) CONNECTOR

(71) Applicant: JAPAN AVIATION ELECTRONICS INDUSTRY, LIMITED, Tokyo (JP)

(72) Inventors: Yuta SHIMOMAKI, Tokyo (JP); Akihiro MATSUNAGA, Tokyo (JP)

(73) Assignee: JAPAN AVIATION ELECTRONICS INDUSTRY, LIMITED, Tokyo (JP)

(21) Appl. No.: 19/062,985

(22) Filed: Feb. 25, 2025

Related U.S. Application Data
(60) Provisional application No. 63/562,362, filed on Mar. 7, 2024.

(30) Foreign Application Priority Data
Nov. 29, 2024 (JP) 2024-209144

(51) Int. Cl. H01R 13/405; H01R 12/72; H01R 13/52

(52) U.S. Cl. CPC H01R 13/405; H01R 12/722; H01R 13/5202

(57) ABSTRACT

A shell block of a connector has a through hole and a receiving portion. The through hole pierces the shell block and has a large aperture portion and a small aperture portion. The large aperture portion is positioned forward of the small aperture portion and communicates with the small aperture portion. The small aperture portion has a first size as a shortest size. The receiving portion is located at a boundary between the large aperture portion and the small aperture portion and faces forward. An insulator member of a contact assembly has a held portion, and the contact assembly is divided by the held portion into a front portion and a rear portion. The held portion is brought into contact with the receiving portion in the through hole. The rear portion has a second size as a tallest size. The second size is smaller than the first size.

### CROSS REFERENCE TO RELATED APPLICATIONS

The present application is based on and claims the benefit of U.S. Provisional Patent Application No. 63/562,362, filed on Mar. 7, 2024, which is incorporated herein by reference in its entirety, and also claims priority under 35 U.S.C. § 119 to Japanese Patent Application No. JP2024-209144 filed Nov. 29, 2024, the contents of which are incorporated herein in their entirety by reference.

### BACKGROUND OF THE INVENTION

This invention relates to a connector, particularly, to a connector which is provided with a contact assembly and a shell block.

JP2024-516208A (Patent Document 1) discloses an example of a connector which is provided with a contact assembly and a shell block.

Referring to FIG. 18, a connector 90 disclosed in Patent Document 1 is provided with a contact assembly 92 and a shell block 94. The contact assembly 92 is attached to the shell block 94 and accommodated in a case 96 of an electronic device together with the shell block 94.

As shown in FIG. 18, the contact assembly 92 is formed with a protruding portion 921 protruding in directions perpendicular to a front-rear direction. On the other hand, the shell block 94 is formed with a stopper 941. The stopper 941 at least partly defines a hole 943 passing through the shell block 94 in the front-rear direction. The contact assembly 92 is inserted into the hole 943 from a rear of the shell block 94 and attached to the shell block 94. The protruding portion 921 of the contact assembly 92 is brought into abutment with the stopper 941 of the shell block 94, so that the contact assembly 92 is positioned in the front-rear direction with respect to the shell block 94.

As shown in FIG. 18, in the connector 90, a rear end portion of the contact assembly 92 is covered with a resin layer 98 at least in part. The resin layer 98 prevents moisture from entering the interior of the electronic device through internal gaps of the contact assembly 92 or a gap between the contact assembly 92 and the shell block 94.

### SUMMARY OF THE INVENTION

With increasing density of parts in an electronic device and increasing in size of built-in battery, there is a demand to reduce a length size of a connector which is an external interface for the electronic device.

It is an object of the present invention to provide a connector having a reduced length size.

One aspect of the present invention provides a connector which is provides with a shell block and a contact assembly. The shell block has a through hole and a receiving portion. The through hole pierces the shell block in a front-rear direction and has a large aperture portion and a small aperture portion. The large aperture portion is located forward of the small aperture portion in the front-rear direction and communicates with the small aperture portion. The large aperture portion is larger than the smaller aperture portion in a plane perpendicular to the front-rear direction. The through hole has a first size as a size of a shortest part of the small aperture portion in an up-down direction perpendicular to the front-rear direction. The receiving portion is provided on a boundary between the large aperture portion and the small aperture portion in the through hole and faces forward in the front-rear direction. The contact assembly comprises at least one contact and an insulator member which fixes and holds the contact. The insulator member has a held portion projecting in directions perpendicular to the front-rear direction. The contact assembly is divided by the held portion into a front portion located forward of the held portion and a rear portion located rearward of the held portion. The held portion is brought into contact with the receiving portion in the through hole. The contact assembly has a second size as a size of a tallest part of the rear portion in the up-down direction. The second size is smaller than the first size.

The connector according to the above-mentioned aspect is formed so that the contact assembly is attached to the shell block from a front of the shell block. This structure can reduce, in the front-rear direction (or a length direction), a size necessary to cover a rear end portion of the contact assembly with a potting resin, so that a size of the rear portion of the connector can be smaller than that of a conventional one.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view partly showing an electronic device provided with a connector according to an embodiment of the present invention. The connector is depicted through a case of the electronic device. A circuit board on which the connector is mounted is provided with a relay connector.

FIG. 2 is another perspective view showing the electronic device of FIG. 1. A relay flexible printed cable is connected to the relay connector on the circuit board.

FIG. 3 is a perspective view showing the connector according to the embodiment of the present invention.

FIG. 4 is an exploded, bottom, perspective view showing the connector of FIG. 3. A potting resin is omitted.

FIG. 5 is an exploded, top, perspective view showing the connector of FIG. 3.

The potting resin is omitted.

FIG. 6 is a cross-sectional, perspective view showing the connector of FIG. 3. A back shell is omitted.

FIG. 7 is a vertical, cross-sectional view showing the connector of FIG. 6.

FIG. 8 is a perspective view showing a contact assembly and a fixing plate which are included in the connector of FIG. 3.

FIG. 9 is a perspective view showing the contact assembly, the fixing plate, a shell block and a waterproof gasket which are included in the connector of FIG. 3. The fixing plate is attached to the contact assembly. The waterproof gasket is attached to the shell block.

FIG. 10 is a vertical, cross-sectional view showing the contact assembly, the fixing plate and the shell block which are included in the connector of FIG. 3.

FIG. 11 is a perspective view showing a modified example of the connector of FIG. 3. The connector is mounted on a circuit board.

FIG. 12 is a perspective view partially showing an electronic device provided with the connector of FIG. 11. The connector is depicted through a case of the electronic device.

FIG. 13 is a vertical, cross-sectional view showing another modified example of the connector of FIG. 3.

FIG. 14 is a vertical, cross-sectional view showing the connector or FIG. 13. The connector is mounted on a circuit board.

FIG. 15 is a front view showing the shell block and the waterproof gasket which are included in the connector of FIG. 5.

FIG. 16 is a front view showing a modified example of the shell block of FIG. 15 and the waterproof gasket.

FIG. 17 is a front view showing another modified example of the shell block of FIG. 15 and the waterproof gasket.

FIG. 18 is a cross-sectional view showing a connector disclosed in Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

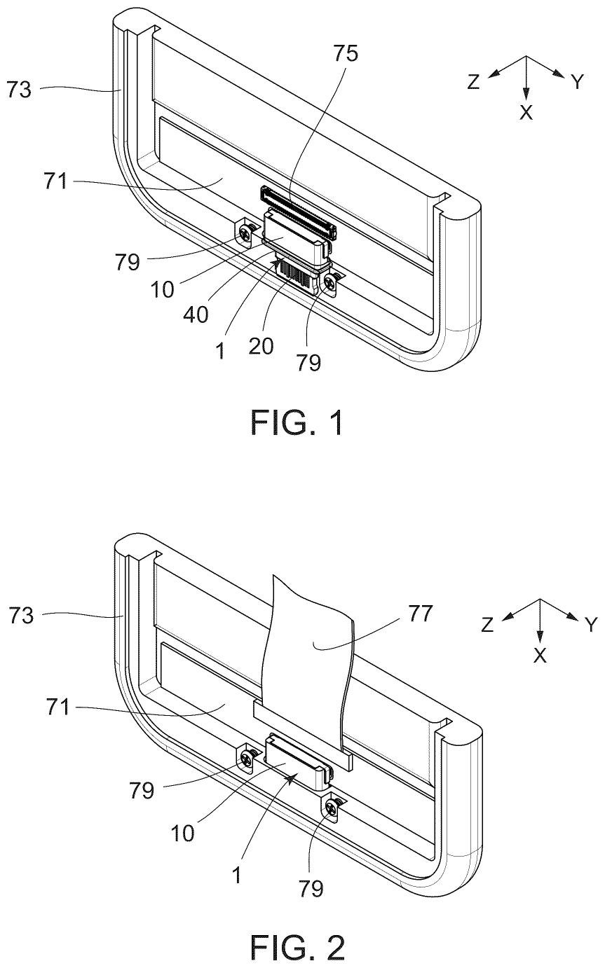

As understood from FIGS. 1 and 2, a connector 1 shown is provided in a case 73 of an electronic device when used and mounded on a circuit board 71 provided in the case 73. A board-to-FPC connector 75 is mounted on the circuit board 71, and a relay flexible printed cable (FPC) 77 is connected to the board-to-FPC connector 75. The connector 1 is detachable with respect to a mating connector (not shown) along a front-rear direction. In the present embodiment, the front-rear direction coincides with a length direction. In the figures, the front-rear direction is an X-direction. A positive X-direction is directed forward while a negative X-direction is directed rearward. The connector 1 shown is a waterproof connector. However, the present invention is also applicable to connectors other than the waterproof connector.

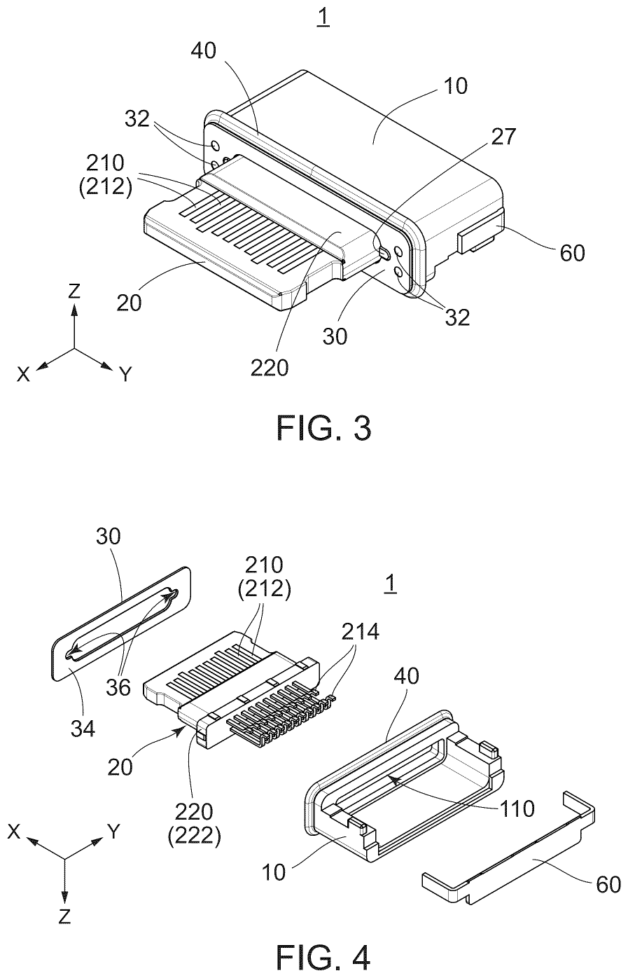

As shown in FIG. 3, the connector 1 is provided with a shell block 10 and a contact assembly 20. As shown in FIGS. 3 to 6, the connector 1 is further provided with a fixing plate 30, a waterproof gasket 40, a potting resin 50 and a back shell 60.

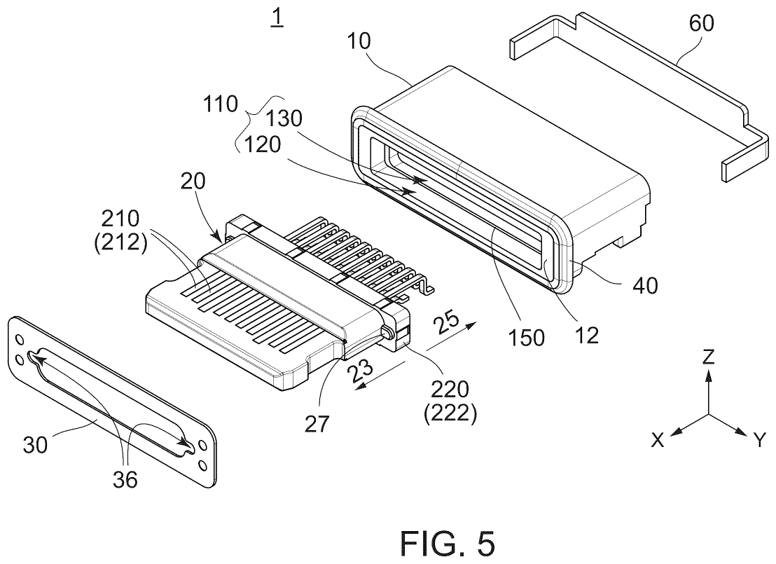

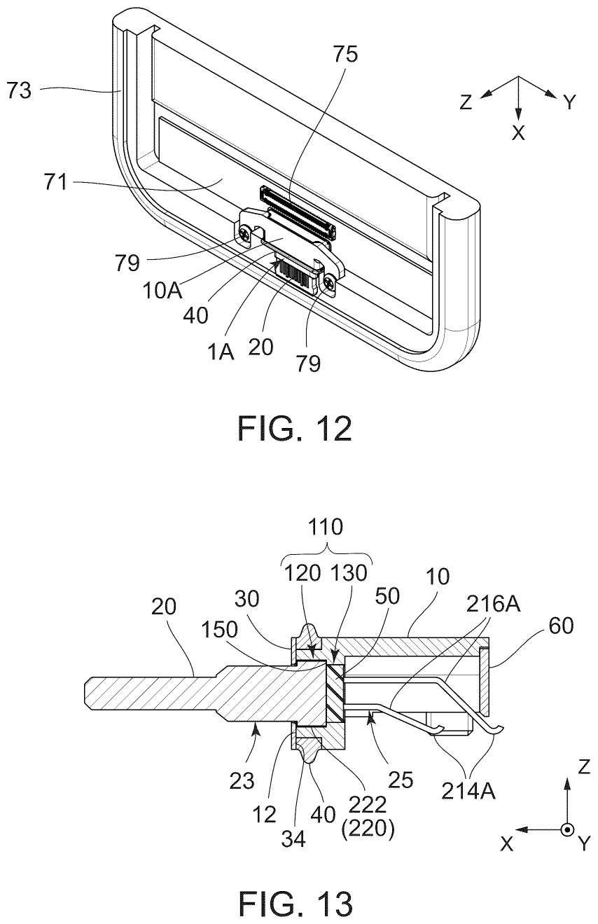

As understood from FIG. 5, the shell block 10 is made by a manufacturing process, such as metal molding or cutting, etc., and it is a structure having thickness elements of a plurality of kindness. The shell block 10 has a through hole 110 and a receiving portion 150. As shown in FIGS. 11 and 12, a shell block 10A of a connector 1A of a modified example may be further provided with a fixed portion 170 which is fixed to the case 73 of the electronic device by the use of screws 79.

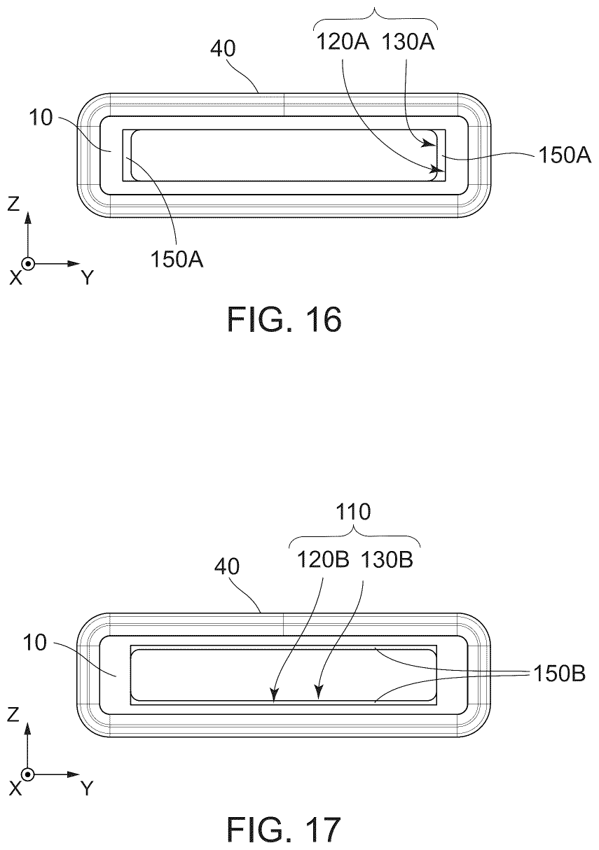

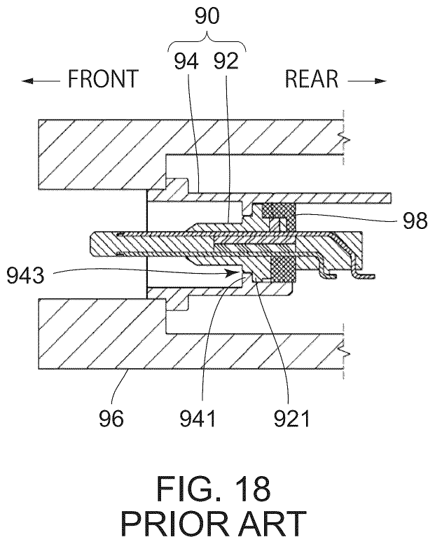

As shown in FIG. 5, the through hole 110 pierces the shell block 10 in the front-rear direction and has a large aperture portion 120 and a small aperture portion 130. The large aperture portion 120 is positioned forward of the small aperture portion 130 in the front-rear direction and communicates with the small aperture portion 130. The large aperture portion 120 is larger than the smaller aperture portion 130 in a plane perpendicular to the front-rear direction. In the figure, the plane perpendicular to the front-rear direction is a Y-Z plane. In detail, as shown in FIG. 15, in the through hole 110 shown, the large aperture portion 120 is larger than the small aperture portion 130 in each of an up-down direction perpendicular to the front-rear direction and a pitch direction perpendicular to both the front-rear direction and the up-down direction. In the figure, the up-down direction is a Z-direction, and the pitch direction is a Y-direction. A positive Z-direction is directed upward while a negative Z-direction is directed downward. However, the present invention is not limited thereto. As a modified example of FIG. 16, a large aperture portion 120A may be larger than a small aperture portion 130A only in the pitch direction. As a modified example of FIG. 17, a large aperture portion 120B may be larger than a small aperture portion 130B only in the up-down direction.

As understood from FIGS. 5 and 15, a step is formed at a boundary between the large aperture portion 120 and the small aperture portion 130. The receiving portion 150 is formed on the step. In detail, the receiving portion 150 is provided on the boundary between the large aperture portion 120 and the small aperture portion 130 in the through hole 110 and faces forward in the front-rear direction. In the shell block 10 shown, the receiving portion 150 has a ring shape. However, the present invention is not limited thereto. For example, in the shell block 10A of FIG. 16, receiving portions 150A are positioned only at both ends in the pitch direction. Moreover, in a shell block 10B of FIG. 17, receiving portions 150B are positioned only at both ends in the up-down direction.

As shown in FIG. 7, the through hole 110 has a first size S1 as a size of a shortest part of the small aperture portion 130 in the up-down direction. In other words, a smallest size of the through hole 110 is the first size S1 in the up-down direction.

As understood from FIGS. 3 to 5, the waterproof gasket 40 is attached to the shell block 10 so that the waterproof gasket 40 surrounds the shell block 10. In detail, the waterproof gasket 40 surrounds a front end of the shell block 10 and vicinity of the front end. The waterproof gasket 40 shown is made of elastic material, such as rubber. The waterproof gasket 40 has a ring shape.

As shown in FIG. 5, the contact assembly 20 is provided with contacts 210 and an insulation member 220 which fixes and holds the contacts 210.

As understood from FIG. 5, the insulation member 220 has a held portion 222 projecting in directions perpendicular to the front-rear direction. The held portion 222 shown is a flange and projects in a plane perpendicular to the front-rear direction. The contact assembly 20 is divided by the held portion 222 into a front portion 23 located forward of the held portion 222 and a rear portion 25 located rearward of the held portion 222. In particular, the front portion 23 shown has a tongue-like shape.

As shown in FIG. 7, the contact assembly 20 has a second size S2 as a size of a tallest part of the rear portion 25 in the up-down direction. In other words, a largest size of the rear portion 25 of the contact assembly 20 is the second size S2 in the up-down direction. The second size S2 is smaller than the first size S1.

As shown in FIG. 5, the contacts 210 are partly embedded in the insulation member 220 by insert molding and held by the insulation member 220. The contacts 210 shown are plural in number and arranged in two, upper and lower, rows. Furthermore, the contacts 210 in each of the rows are arranged in the pitch direction.

As understood from FIGS. 5 to 7, the contact 210 has a contact portion 212 and a connection portion 214. The contact portion 212 is located at the front portion 23 of the contact assembly 20. The contact portion 212 shown is exposed upward or downward of the front portion 23. The contact portion 212 is brought into contact with a mating contact (not shown) with which the mating connector (not shown) is provided in a connection state of the connector 1 and the mating connector. The connection portion 214 is located at the rear portion 25 of the contact assembly 20. In the connector 1 shown, the rear portion 25 is formed of only parts of the contacts 210. However, the present invention is not limited thereto. The rear portion 25 may include a part of the insulation member 220.

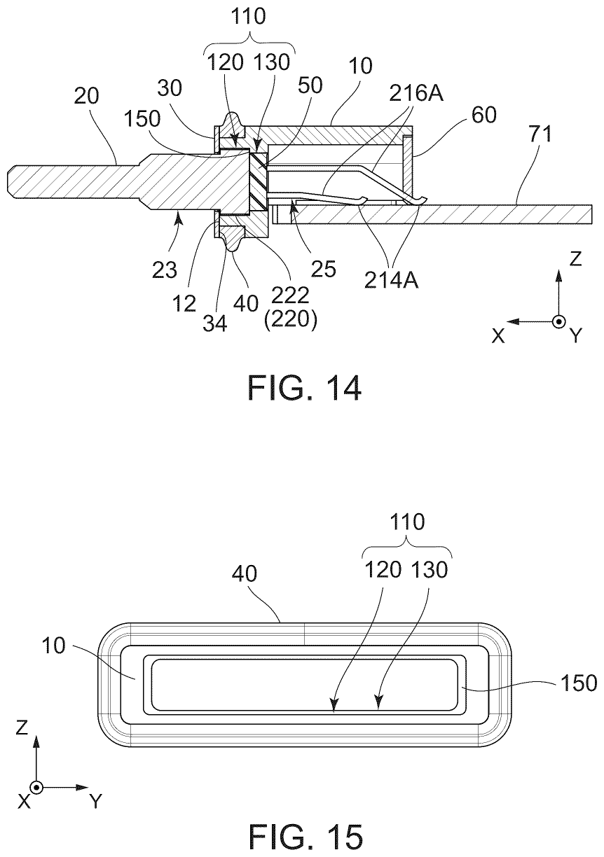

As understood from FIGS. 1, 3 and 5, when the connector 1 is mounted on the circuit board 71, the circuit board 71 is arranged under the rear portion 25 of the contact assembly 20. The connection portion 214 of the contact 210 is connected to a conductor (not shown) on the circuit board 71 when the connector 1 is mounted on the circuit board 71. In detail, the connection portion 214 shown is soldered to the conductor on the circuit board 71. However, the present invention is not limited thereto. For example, as understood from FIGS. 13 and 14, a connection portion 214A of a modified example may be supported by a supporting portion 216A, which is resiliently deformable, and brought into contact with the conductor on the circuit board 71 by using resilient deformation of the supporting portion 216A.

As shown in FIG. 7, the shell block 10 holds the insulation member 220 of the contact assembly 20 by using the fixing plate 30. Specifically, the fixing plate 30 is fixed to the shell block 10. Furthermore, the held portion 222 is sandwiched between the fixing plate 10 and the receiving portion 150 in the front-rear direction. Accordingly, the held portion 222 is fixed in position in the front-rear direction. In the state, the held portion 222 is brought into contact with the receiving portion 150 in the through hole 110. As an alternative for holding the insulation member 220 by the shell block 10, it is conceived to press-fit the held portion 222 into the through hole 110 or thermally weld the held portion 222 in the through hole 110. Though the receiving portion 150 has the ring shape while the held portion 222 has a flange shape in the connector 1 of FIG. 5, the present invention is not limited thereto. Provided that the held portion 222 is brought into contact with the receiving portion 150 and is held by the shell block 10, it can have various shapes.

As understood from FIGS. 3 and 7, the fixing plate 30 shown is fixed to the shell block 10 by laser welding. As a result, as shown in FIG. 3, welding portions 32 are formed. However, the fixing method of the fixing plate 30 to the shell block 10 is not limited thereto. For example, latches may be provided to the fixing plate 30, and the latches may be set on the shell block 10. Alternatively, the fixing plate 30 may be press-fitted into the shell block 10, or the fixing plate 30 may be bonded to the shell block 10. Furthermore, though the fixing plate 30 shown is fixed to a front surface 12 of the shell block 10, it may be disposed in and fixed to the large aperture portion 120 of the through hole 110.

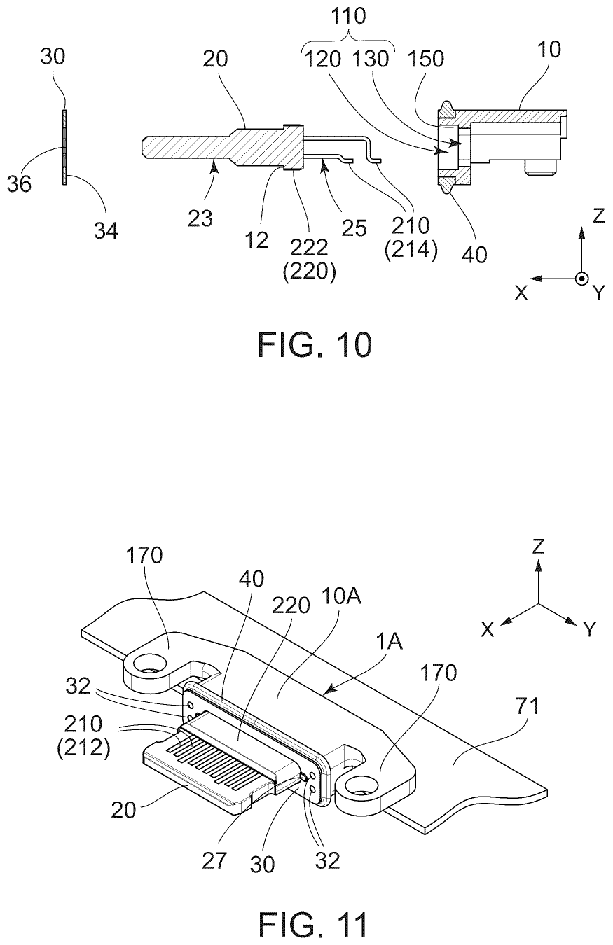

As shown in FIGS. 4 and 10, the fixing plate 30 has a main back surface 34. As understood from FIGS. 7 and 10, when the fixing plate 30 is fixed to the shell block 10, the main back surface 34 is brought into contact with the front surface 12 of the shell block 10 and is pressed against the waterproof gasket 40. The main back surface 34 is pressed against the waterproof gasket 40, so that the potting resin 50 which is filled into the small aperture portion 130 of the connector 1 from behind is prevented from leaking forward, and water is prevented from entering the inside of the connector 1. In the present embodiment, the main back surface 34 of the fixing plate 30 is a flat surface. However, the main back surface 34 may be provided with a protruding portion protruding backward. In that case, the protruding portion may have a size and a shape which are suitable to be pressed against the waterproof gasket 40. The protruding portion may have a ring shape to overlap the waterproof gasket 40 when seen in the front-rear direction, for example.

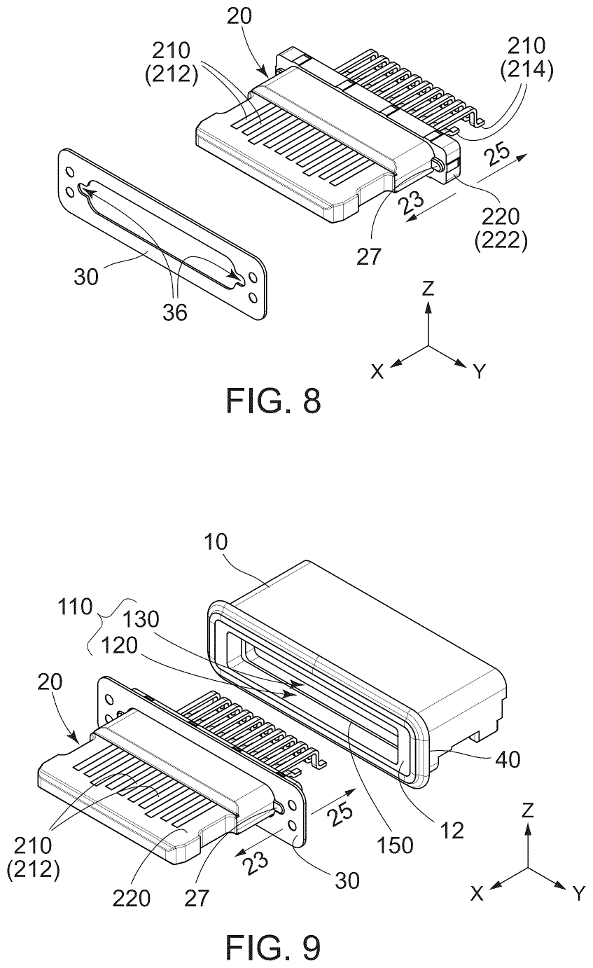

As shown in FIG. 8, the contact assembly 20 is provided with temporary holding portions 27. As understood from FIGS. 5 and 8, in the connector 1 shown, the temporary holding portions 27 are protrusions protruding forward from the insulation member 220. The fixing plate 30 shown is provided with temporary held portions 36. In the connector 1 shown, the temporary held portions 36 are notches. The temporary holding portions 27 temporarily hold the temporary held portions 36, so that a relative position of the fixing plate 30 is fixed with respect to the contact assembly 20. As understood from FIGS. 8 and 9, in the connector 1 shown, the protrusions or the temporary holding portions 27 of the insulation member 220 are press-fitted into the notches or the temporary held portions 36, so that the relative position of the fixing plate 30 is fixed with respect to the contact assembly 20. Accordingly, the fixing plate 30 is prevented from being rattled when the fixing plate 30 is fixed to the shell block 10.

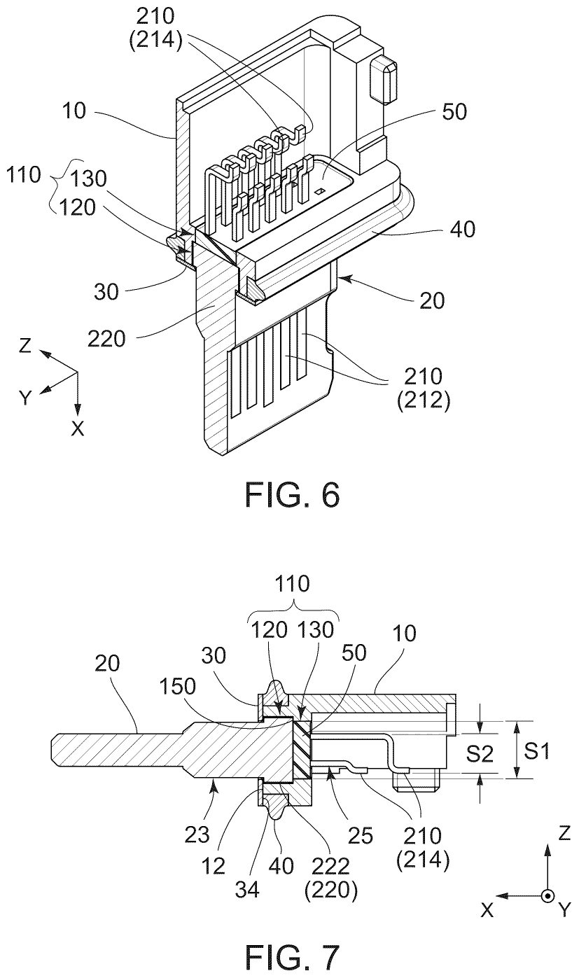

As shown in FIG. 6, the potting resin 50 is filled into the small aperture portion 130. The small aperture portion 130 has an edge which is positioned at a rear end of the small aperture portion 130 in the front-rear direction. The potting resin 50 has a lower end and an upper end in the up-down direction. The lower end of the potting resin 50 does not extend rearward beyond the edge of the small aperture portion 130. Furthermore, the upper end of the potting resin 50 shown does not extend rearward beyond the edge of the small aperture portion 130. Namely, the potting resin 50 shown remains within the small aperture portion 130. However, the present invention is not limited thereto, and the upper end of the potting resin 50 may extend rearward beyond the edge of the small aperture portion 130. The potting resin 50 stops water entering the connector 1 through interfaces between each of the contacts 210 and the insulation member 220 holding the contacts 210 and an interface between the through hole 110 of the shell block 10 and the insulation member 220.

As understood from FIGS. 3 and 5, the back shell 60 is fixed to the shell block 10 and covers a rear end of the shell block 10. The back shell 60 has a shield effect to prevent interference of electromagnetic energy from high-frequency signals transmitted on the contacts 210 to peripheral parts. In addition, the back shell 60 prevents entering of dust and foreign substances and deformation of the connection portion 214 (see FIG. 6) made from rearward of the connector 1.

As described with reference to FIG. 7, in the connector 1 of the present invention, the second size S2 or the size of the tallest part of the rear portion 25 is smaller than the first size S1 or the size of the shortest part of the small aperture portion 30. In other words, the size of the tallest part of the rear portion 25 of the contact assembly 20 is smaller than the size of the shortest part of the through hole 110 of the shell block 10. Accordingly, as understood from FIGS. 7, 9 and 10, the rear portion 25 having the connection portions 214 can be inserted into the through hole 110 of the shell block 10. That is, the contact assembly 20 can be assembled with the shell block 10 from a front of the shell block 10. Furthermore, as described with reference to FIG. 6, this structure can sufficiently show a water stop effect even if the lower end of the potting resin 50 does not extend rearward beyond the edge of the small aperture portion 130. Accordingly, a size of the connector 1 can be reduced in the length direction or the front-rear direction.

Although the specific explanation about the present invention is made above with reference to concrete embodiments, the present invention is not limited thereto but susceptible of various modifications and alternative forms without departing from the spirit of the invention. For example, the contacts 210 with which the contact assembly 20 is provided may be freely decided in number and in arrangement. Moreover, the contact assembly 20 may have a mid-plate positioned at the middle thereof in the up-down direction.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector comprising a shell block and a contact assembly, wherein:
the shell block has a through hole and a receiving portion;
the through hole pierces the shell block in a front-rear direction and has a large aperture portion and a small aperture portion;
the large aperture portion is located forward of the small aperture portion in the front-rear direction and communicates with the small aperture portion;
the large aperture portion is larger than the smaller aperture portion in a plane perpendicular to the front-rear direction;
the through hole has a first size as a size of a shortest part of the small aperture portion in an up-down direction perpendicular to the front-rear direction;
the receiving portion is provided on a boundary between the large aperture portion and the small aperture portion in the through hole and faces forward in the front-rear direction;
the contact assembly comprises at least one contact and an insulator member which fixes and holds the contact;
the insulator member has a held portion projecting in directions perpendicular to the front-rear direction;
the contact assembly is divided by the held portion into a front portion located forward of the held portion and a rear portion located rearward of the held portion;
the held portion is brought into contact with the receiving portion in the through hole;
the contact assembly has a second size as a size of a tallest part of the rear portion in the up-down direction; and
the second size is smaller than the first size.

2. The connector as recited in claim 1, wherein:
the connector further comprises a fixing plate fixed to the shell block;
the held portion is sandwiched between the fixing plate and the receiving portion of the shell block in the front-rear direction; and
the contact assembly is fixed to the shell block.

3. The connector as recited in claim 2, wherein:
the connector further comprises a waterproof gasket;
the waterproof gasket has a ring shape; and
the waterproof gasket is attached to the shell block so that the waterproof gasket surrounds the shell block.

4. The connector as recited in claim 3, wherein:
the shell block has a front end;
the waterproof gasket surrounds the front end of the shell block and a vicinity of the front end;
the fixing plate has a main back surface; and
when the fixing plate is fixed to the shell block, the main back surface is brought into contact with the front end of the shell block.

5. The connector as recited in claim 2, wherein:
the contact assembly is provided with a temporary holding portion;
the fixing plate is provided with a temporary held portion; and
the temporary holding portion temporarily holds the temporary held portion, so that a relative position of the fixing plate is fixed with respect to the contact assembly.

6. The connector as recited in claim 1, wherein:
the connector is mounted on a circuit board arranged under the rear portion in the front-rear direction when used;
the contact has a connection portion which is connected to a conductor on the circuit board when the connector is mounted on the circuit board;
the connector further comprises a potting resin filled into the small aperture portion;
the small aperture portion has an edge which is positioned at a rear end of the small aperture portion in the front-rear direction;
the potting resin has a lower end in the up-down direction; and
the lower end of the potting resin does not extend rearward beyond the edge of the small aperture portion.

7. The connector as recited in claim 1, wherein the connector further comprises a back shell which is fixed to the shell block and covers a rear end of the shell block.

8. The connector as recited in claim 1, wherein:
the connector is provided in a case of an electronic device when used; and
the shell block is provided with a fixed portion fixed to the case of the electronic device.
